(19) United States
(12) Patent Application Publication
(10) Pub. No.: US 2002/0111851 A1
(43) Pub. Date: Aug. 15, 2002

(54) Electronic parking system

(76) Inventor: Joie L. Folkers, Houston, TX (US)

Correspondence Address: JOIE L. FOLKERS, 16806 FLOWER MIST LANE, HOUSTON, TX, 77095, US

(21) Appl. No.: 09/784,400

(22) Filed: Feb. 15, 2001

(51) Int. Cl. G06F 17/60

(52) U.S. Cl. 705/13

(57) ABSTRACT

A detection, identification and control system for premium parking spaces in public parking areas owned by merchants, businesses or private organizations. Electronic hardware similar to that used for an automatic toll booth is modified to detect the time period of an occupied parking space and to identify the parking space location. Pre-programmed fees for space occupancy are assessed to discrete locations due to their convenience or enhanced features. Variation of the fees is possible for peak seasons, such as holidays.

### BACKGROUND OF THE INVENTION

1. Field of Invention

This invention relates to a system to automatically detect, identify and assess a fee for parking a subscriber vehicle in a designated, preferred parking space.

2. Description of Prior Art

Public parking lots, such as those adjacent to shopping malls, restaurants, businesses, recreation areas, sports arenas and other facilities and buildings often have designated parking spaces for handicapped patrons, members or employees. These spaces are the most proximate to the entrance of the establishment and are designed for convenience and ease of access. Most commonly, all other parking spaces are equal in size and features. The only distinction being their distance to the exit point of the lot or entry to the establishment they support.

The present invention will provide a means to identify additional preferred parking spaces and allow patrons, members or employees to have exclusive access to those spaces. In order to do this, a system must be installed which will detect the presence of a vehicle, validate it being allowed to occupy the space, identify the specific vehicle or owner, identify the space and charge (as applicable) a fee to the account of the owner.

Prior inventors have devised means to perform many of these tasks on vehicles moving through toll gates, for example, but the application for use in parking is not raised.

U.S. Pat. No. 5,896,190 to Wangler (1999) includes a means of detecting the presence of a vehicle but does not identify the type or the specific vehicle which is detected. The system described in U.S. Pat. No. 5,872,525 to Fukasawa (1999) detects the entrance of a vehicle and its type into a toll zone. The exit of the zone is detected by a remote sensor which is dislocated from the first. No time element is identified in the invention which would be essential in the present system.

An accelerometer disclosed in U.S. Pat. No. 5,796,084 to Olsson (1998) discriminates between time a vehicle is moving vs. stationary, however its location is not specifically identified.

U.S. Pat. No. 5,675,494 to Sakurai (1997) detects entry of a vehicle into a toll area and sets a limit (lag) for the time before a second toll can be charged. The purpose of this is to avoid double charging the toll rather than detecting the time the toll is in effect. Claus (1994) describes a system that detects passage of a discrete vehicle in U.S. Pat. No. 5,310,999. The system does not detect a time period and would not be useful in a toll parking system.

U.S. Pat. No. 4,963,723 to Masada (1990) describes entry and exit through separate gates for calculating tolls on a toll road. An on-board IC card is used to identify the vehicle. No detection of time is disclosed in the system. Separate sensors are used to detect the passage of the IC card to activate the toll system.

### Objects and Advantages

Accordingly, several objects and advantages of my invention are:

(a) to provide a means to detect the presence of a vehicle in a designated parking space.

(b) to provide a means to discriminate between a vehicle which includes a valid identification device.

(c) to provide a means which uniquely identifies a vehicle which includes a valid identification device.

(d) to provide a means by which the entry of the subscriber vehicle and its remaining in the space are detected.

(e) To provide a means by which the exit of the subscriber vehicle is detected.

(f) To provide a means by which the duration of time the vehicle occupied the space is determined.

(g) To provide a means by which the location used is identified to the patron in a periodic billing notice.

(h) To provide a means by which the parking time can be compared to a toll schedule and the correct fee assessed.

(i) To provide a means for vehicle operators to choose preferred parking places at their discretion, according to their availability and the operator's willingness to accept (additional) charge.

(j) To provide a means by which vehicle operators may subscribe to preferred parking.

(k) To provide a means for non-subscriber vehicles to be identified and notification signaled to the operator and the system monitor that unauthorized use of the space has begun.

(l) To provide a means for subscriber accounts to be pre-paid to a system operator.

(m) To provide a means to deduct tolls from the correct account and remit to parking operator.

(n) To provide a system for which a single subscription is usable in multiple locations.

(o) To provide a system which will be treated preferentially by the location operator.

Said preferential treatment may include increased spacing, curbing, covered parking, covered entry to the establishment or other enhancements.

(p) To provide a means by which a parking lot or garage owner may select and identify premium parking spaces for which a toll is assessed.

(q) To provide a system which can be used to reward individuals by allowing preferred parking, to identify members thereby preventing unauthorized parking or other discriminating features.

(r) To provide a system to display (at the entrance to the parking lot, for example) the number of preferred spaces available at a given time.

Further advantage of the system may include extension of the enhanced features to the handicapped spaces due to their proximity to the preferred, premium spaces.

### DRAWING FIGURES

In the drawings, like elements have the same number.

FIG. 1 is an elevation view of the general system showing the vehicle, sensor and transmitter.

FIG. 2 shows a more detailed view of the sensor and its mounting stanchion. Different configuration of this device may be used.

FIG. 3 shows a plan view of a typical business and parking lot equipped with the system and with designated parking for handicapped and preferred parking.

FIG. 4 is a detailed plan view of a parking space with the possible accompanying curbing, cover and identification.

### SUMMARY

In accordance with the present invention a device and system installed in a parking lot to provide a means of preferred, premium, toll parking with features for detecting, identifying and assigning charges to a vehicle entering the parking space. Assignment of number and cost for use of such spaces is at the discretion of the lot owner or operator and can be varied according to seasonal demand, value of features or proximity to lot exit or business entrance.

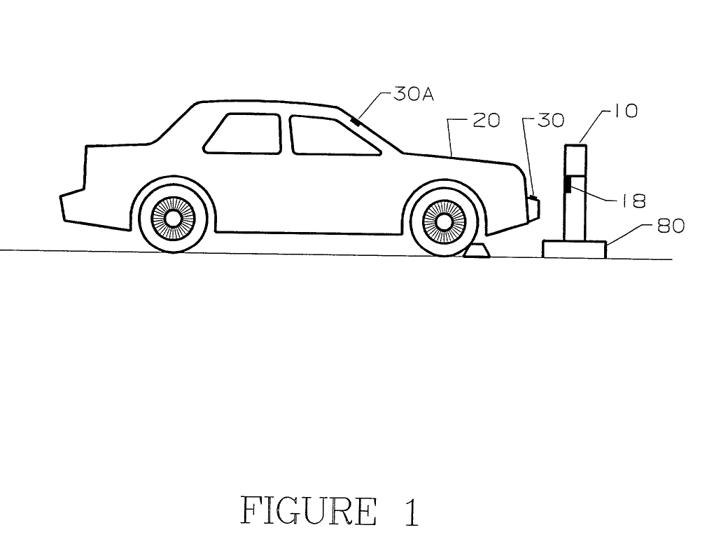

### DESCRIPTION—FIGS. 1 to 4

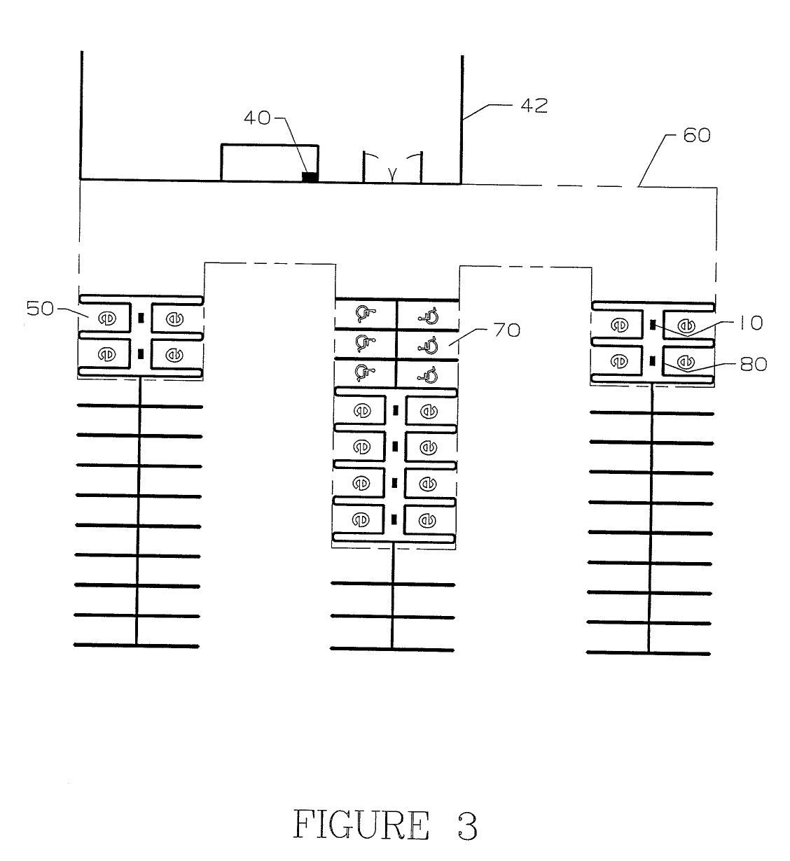

A typical embodiment of the invention is shown in FIG. 1. The subscriber vehicle 20 contains a transmitter 30 which is mounted on the vehicle. The transmitter 30 may be outside the passenger compartment of the vehicle for the purpose of close proximity to the sensor stanchion 10 or mounted in the vehicle (30A) for ease of monitoring by the driver. The sensor stanchion 10 contains the vehicle detection and identification sensor 18. Said device detects the presence of a vehicle, determines whether the vehicle has a valid transmitter, identifies the specific transmitter/owner and communicates with the control system the time of entry and duration of parking for that vehicle. The control system 40 (ref. FIG. 3) calculates and assesses toll fee for the parking to the proper subscriber account.

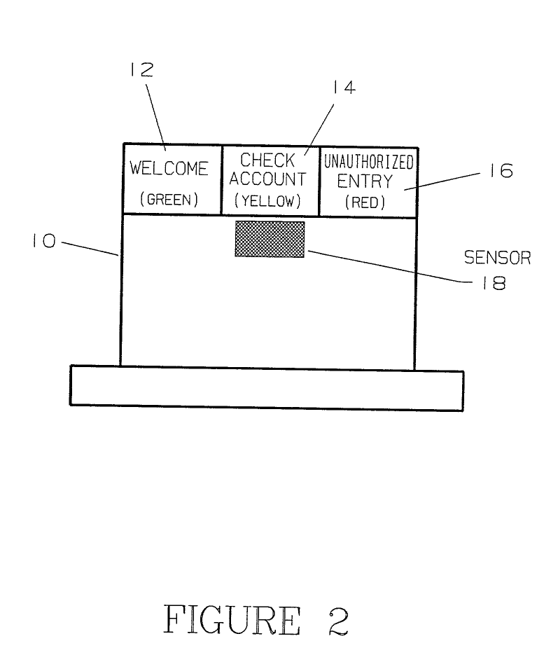

FIG. 2 shows a possible embodiment of the sensor stanchion 10. Three signal devices may be used to indicate the validity of the vehicle entrance. An indicator 12 may be green in color and indicate “Welcome” for subscriber vehicles with account balances above a prescribed limit. A second indicator 14 may be used, yellow in color, to indicate the subscriber is approaching a low or zero balance and additional funds are needed in their account to maintain the privilege of using the space. This may also be used in conjunction with the indicator 12 in green. A third indicator 16 can be used to indicate invalid or unauthorized entry into the space or a zero balance for a subscriber vehicle. This indicator can be accompanied by a sounding device and alarm device to the control system 40 for a monitor to investigate the event and direct appropriate action. In the style embodiment of the stanchion 10, space may be allocated for advertizing.

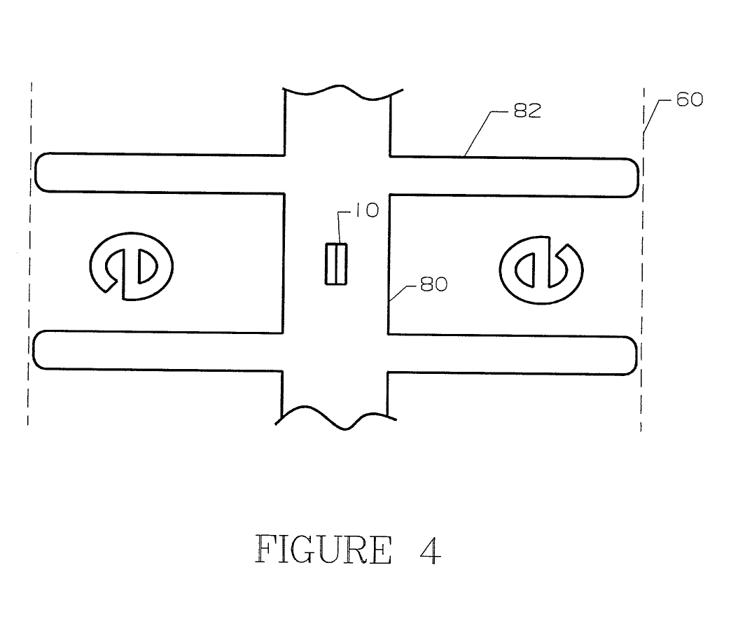

FIG. 3 shows the layout for a possible system. Multiple stanchions 10 are located in a parking lot outside a business 42. Inside the building a control system 40 is mounted to monitor activity in the parking system. Individual spaces are identified for handicapped parking 70 and for preferred or premium parking 50, denoted by an “e” or other symbol. Features of the premium parking may include but are not limited to curbing and walkway space 80 between rows of vehicles, curbing between vehicles 82 (ref. FIG. 4) or covering materials 60. The covering materials 60 may extend from the spaces to the building entrance and may include the handicapped spaces as a courtesy. Covered area is shown with a dashed line in the figure. Note that all spaces in the lot are not designated for premium parking nor do they all have the same features or dimensions. These features are at the discretion of the lot operator.

FIG. 4 shows a detailed view of the individual space with curbing between vehicles 82 more clearly identified.

I claim:

1. A detection system of the type comprising a sensor and identification means for detecting and identifying a vehicle occupying a designated parking space and a control means for signaling the authorized or unauthorized occupancy of said and assessing a fee.

2. The system of claim 1 wherein an electronic transmitting device is used to detect the presence of a vehicle in a designated parking space and identify said vehicle regarding its authorized occupation of the space.

3. The electronic transmitting device of claim 2 wherein the device will identify the parking space.

4. The electronic transmitting device of claim 2 wherein a vehicle unauthorized to occupy the space will cause a signal to be generated, alerting the vehicle driver and the electronic system operator of the unauthorized occupation of the space.

5. The electronic transmitting device of claim 2 wherein the device is connected to a control system capable of assessing the status of the vehicle account identified in the occupied space.

6. The system of claim 1 wherein an identifying device is fixedly mounted or carried within a vehicle to identify the vehicle as authorized to occupy the space.

7. The identifying device of claim 6 wherein a means will identify the vehicle occupying the space to the system operator.

8. The identifying device of claim 6 wherein each of multiple devices has a unique signature.

9. The identifying device of claim 6 wherein the same device can be used to identify the vehicle for use of toll roads, gasoline purchases or many other activities.

10. The identifying device of claim 6 wherein a charge can be assessed to a subscriber account.

11. The control system of claim 1 wherein the status of an account can be signaled within the electronic transmitting device.

12. The system of claim 1 wherein the duration of occupancy of the space by the vehicle is sensed.

13. The system of claim 12 wherein a minimum time period can be set to avoid false detection of occupancy by an authorized vehicle.

14. The system of claim 1 wherein a program can be input to assign a cost for occupancy of parking spaces.

15. The program of claim 14 wherein a fee structure can be input by the system operator.

16. The system of claim 1 wherein the program can be changed by the system operator.
